(19) United States
(12) Patent Application Publication
(10) Pub. No.: US 2026/0297369 A1
(43) Pub. Date: Oct. 1, 2026

(54) COATING COMPOSITION FOR RUBBER SEALING MEMBER

(71) Applicants: THE CHEMOURS COMPANY FC, LLC, WILMINGTON, DE (US); CHEMOURS-MITSUI FLUOROPRODUCTS CO., LTD., TOKYO (JP)

(72) Inventor: HOAI-NAM PHAM, SHIZUOKA (JP)

(73) Assignees: THE CHEMOURS COMPANY FC, LLC, WILMINGTON, DE (US); CHEMOURS-MITSUI FLUOROPRODUCTS CO., LTD, TOKYO (JP)

(21) Appl. No.: 19/481,225

(22) PCT Filed: May 17, 2024
(86) PCT No.: PCT/US2024/029825

§ 371 Date: Nov. 4, 2025

(30) Foreign Application Priority Data
May 18, 2023 (JP) 2023-082365

(51) Int. Cl. C09D 127/18; C08K 3/04; C09D 7/61; C09D 7/65

(52) U.S. Cl. CPC C09D 127/18; C08K 3/04; C09D 7/61; C09D 7/65

(57) ABSTRACT

To provide a paint composition capable of forming a coating film with excellent durability, which can be used for rubber sealing members used in contact with metal, and which can exhibit excellent adhesion to the sealing member itself and non-adhesiveness to the metal product that is the counterpart material over a long period of time. A paint composition for rubber sealing members containing hydrogenated acrylonitrile butadiene rubber and perfluorofluororesin, wherein the ratio of said hydrogenated acrylonitrile butadiene rubber to said perfluorofluororesin (solid mass ratio) is 25:75 to 55:45.

### CROSS REFERENCE TO RELATED APPLICATIONS

This application claims the benefit of priority of Japanese Application No. 2023-082365 filed May 18, 2023, the disclosures of which are incorporated herein by reference in its entirety.

The present invention relates to a fluororesin coating composition that can be suitably applied to rubber sealing members, and more specifically to a fluororesin coating composition that can provide excellent tack-free properties toward metals to rubber sealing members that come in contact with metal.

### CONVENTIONAL TECHNOLOGY

Seal rings and rubber sealing members such as gaskets, valve seals, and check valves are widely used in automobiles, industrial machinery, and other fields. Rubber sealing members may have a film containing a coating agent made of rubber components and fluororesin particles formed on a surface of the rubber sealing member to prevent tackiness to the opposing material and to enable instantaneous opening and closing of the seal.

For example, Patent Document 1 below discloses a coating agent for oil-seals prepared as an organic solvent solution containing a total of 10 to 90 parts by weight of fluoropolymer particles with a particle size of 2 μm or less and filler particles other than fluoropolymer particles with a particle size of 0.5 to 30 μm and 10 to 40 parts by weight of wax with a melting point of 40 to 160° C., in proportion to 100 parts by weight of 1,2-polybutadiene containing an isocyanate group, wherein the fluoropolymer particles at a ratio of 20 to 80% by weight of the total amount of filler.

Furthermore, the present inventors proposed a coating composition capable of forming a coating film that can express excellent releasability over a long period of time for a substrate having inferior heat resistance such as a rubber or plastic substrate (see Patent Document 2 below). This coating composition also has high coating film adhesion to the substrate, so use on rubber sealing members such as those described above is also being considered.

### PRIOR ART DOCUMENTS

### Patent Documents

Patent Document 1: International Publication WO 2021/014901
Patent Document 2: Japanese Unexamined Patent Application Publication 2022-136748

### SUMMARY OF THE INVENTION

### Problem to be Solved by the Invention

Rubber sealing members used in contact with metal are required to have tack-free properties so that they do not stick to metal even when lightly touched, so as not to impair sealing performance (to prevent adhesion to metal members by seal rings and gaskets, and to enable instantaneous opening and closing in valve seals and valves). However, it was found that a coating film made of the coating composition described in Patent Document 2 is excellent in terms of providing mold-releasing properties to bladders and the like, but is unable to control tack-free properties (non-tacking properties) as required for metals.

Therefore, an object of the present invention is to provide a coating composition capable of forming a coating film with excellent durability, which can be used for a rubber sealing member that is used in contact with metal, and which can exhibit excellent adhesion to rubber substrates and tack-free properties (non-tacking properties) to a metal member that is the opposing material, over a long period of time.

Another object of the present invention is to provide a rubber sealing member such as a seal ring, gasket, valve seal, check valve, or the like, having a coating film with excellent tack-free (non-tacking) properties to metal members.

### Means to Solve the Problem

The present invention provides a coating composition for a rubber sealing member containing hydrogenated acrylonitrile butadiene rubber (hereinafter also referred to as HNBR) and a perfluoro fluororesin (hereinafter also simply referred to as fluororesin), wherein the ratio of hydrogenated acrylonitrile butadiene rubber to perfluoro fluororesin (solid mass ratio) is 25:75 to 55:45.

Preferably, with the coating composition for a rubber sealing member:
(1) the perfluoro fluororesin is a hot-melt perfluoro fluororesin;
(2) the hot-melt perfluoro fluororesin is tetrafluoroethylene hexafluoropropylene copolymer;
(3) a silane coupling agent is included;
(4) the hydrogenated acrylonitrile butadiene rubber and the perfluoro fluororesin are aqueous dispersion solutions, and form an aqueous coating composition; and
(5) the composition ratio of the hydrogenated acrylonitrile butadiene rubber and the perfluoro fluororesin (solid mass ratio) is 35:65 to 50:50.

The present invention also provides a rubber sealing member, comprising a surface with a coating film containing hydrogenated acrylonitrile butadiene rubber and perfluoro fluororesin in a composition ratio of 25:75 to 55:45 (solid mass ratio).

Preferably, with the rubber sealing member of the present invention:
(1) the perfluoro fluororesin is a hot-melt perfluoro fluororesin;
(2) the hot-melt perfluoro fluororesin is tetrafluoroethylene hexafluoropropylene copolymer;
(3) the tack force (peak value) received by a probe is 20 gf or less when a 5 mm diameter probe (SUS304 material) at room temperature is pressed against the coating film at a speed of 5 mm/min and a load of 100 gf, held at a load of 100 gf for 3 seconds, and then pulled away at a speed of 10 mm/min; and
(4) the rubber sealing member is a seal ring, gasket, valve seal or check valve.

### Effect of the Invention

The coating composition for a rubber sealing member of the present invention can impart tack-free (non-tacking) properties to rubber sealing members to prevent any adhesion whatsoever even after light contact with metal, which is the opposing material, as well as excellent abrasion resistance, in order to enable suitable expression of the sealing performance expected of rubber sealing members, and the excellent tack-free properties can be maintained for a long period of time.

The coating composition for a rubber sealing member of the present invention can form a coating film with excellent tracking properties at low temperature, even for rubber sealing members that are elastic and do not have high heat resistance. The coating composition also has excellent durability.

Furthermore, the coating composition for a rubber sealing member can be a water-based coating composition where HNBR and fluororesin are dispersed in water, which is excellent from an environmental and cost perspective.

Furthermore, rubber sealing members such as seal rings and check valves that have a coating film made of the coating composition of the present invention have excellent tack-free properties and do not stick when in contact with metal, and thus the sealing performance of the rubber sealing member is maintained without loss.

Furthermore, the coating composition can also form a coating film at low temperature on the surface of a rubber sealing member that has poor heat resistance, and thus the coating composition has excellent productivity.

### EMBODIMENTS OF THE INVENTION

### (Coating Composition)

The coating composition for a rubber sealing member of the present invention is a coating composition containing hydrogenated acrylonitrile butadiene rubber and perfluoro fluororesin, and the composition ratio of the HNBR to the fluororesin (solid mass ratio) is 25:75 to 55:45, and a ratio of 35:65 to 50:50 is particularly preferable. If the amount of HNBR blended is less than the aforementioned range, forming a contiguous coating film will be more difficult than in the aforementioned range, which may cause coating film defects such as cracks, and may reduce adhesion between the rubber sealing member and the coating film. On the other hand, if the amount of HNBR added is higher than the aforementioned range, achieving the desired tack-free properties in the coating film will be more difficult than when the amount is within the aforementioned range.

### [Hydrogenated Acrylonitrile Butadiene Rubber (HNBR)]

In the coating composition of the present invention, HNBR, which serves as the base resin, has properties of heat resistance, durability after vulcanization, adhesiveness with rubber sealing members, and tack-free properties, as well as the ability to maintain elongation at 50% or more after the coating film is formed.

The HNBR is used in an unvulcanized condition and is vulcanized when forming the coating film. The vulcanization treatment temperature can be 200° C. or lower (and preferably 180° C. or lower). Therefore, the coating composition of the present invention can be used without any problem on a rubber sealing member that can be used at or above that temperature.

The HNBR preferably has a hydrogenation ratio of 80 to 99%. Furthermore, the acrylonitrile content should be in a range of 18 to 50% by mass. Furthermore, the Mooney viscosity ML (1+4) at 100° C. (in accordance with JIS K6300) is preferably within a range of 30 to 150.

When the coating composition of the present invention is a water-based coating composition, aqueous dispersions (latex) of HNBR prepared by conventionally known methods are suitably used.

### [Perfluoro Fluororesin]

With the coating composition of the present invention, the inclusion of perfluoro fluororesin reduces the surface energy of the coating film, which improves the slipperiness and controls the tack-free properties of the coating film. Furthermore, wear resistance is also improved by reducing the coefficient of friction. Thus, the tack-free properties are maintained over a long period of time, and therefore, the durability is also improved.

Furthermore, as will be described later, when baking is performed at a temperature of approximately 180° C. when forming the coating film, the fluororesin particles do not melt in the formed coating film, and the fluororesin particles form a sea-island structure where the fluororesin particles become islands in a matrix (sea) made of HNBR. Thus, the elasticity of the coating film made of HNBR is not impaired.

Although not restricted to these, examples of the perfluoro fluororesins include polytetrafluoroethylene (PTFE); hot-melt perfluoro fluororesins such as low molecular weight polytetrafluoroethylene (low molecular weight PTFE), tetrafluoroethylene perfluoro (alkylvinyl ether) copolymer (PFA), tetrafluoroethylene hexafluoropropylene copolymer (FEP), tetrafluoroethylene/hexafluoropropylene/perfluoro (alkyl vinyl ether) copolymer, and the like. Of these, hot-melt perfluoro fluororesins, especially FEP, can be suitably used.

As described below, forming a coating film on a rubber sealing member by high temperature processing is difficult, so FEP, which has a low melting point among fluoropolymers, can be used to form a favorable coating film on a rubber sealing member. The adhesion to rubber sealing materials is also superior to that of other fluororesins, as is clear from the results of the examples described below.

The FEP may be a copolymer containing only tetrafluoroethylene (TFE) and hexafluoropropylene (HFP), or a copolymer containing polymerized units of TFE, HFP, and monomers that can copolymerize with TFE and HFP. Polymer units based on monomers that can copolymerize with TFE and HFP include perfluoro (alkyl vinyl ether), and the like.

The amount of tetrafluoroethylene (TFE) in the FEP should be in a range of 75 to 97% by mass.

The melt flow rate (MFR) of the hot-melt fluoropolymer should be 1 to 100 g/10 min, more preferably 1 to 80 g/10 min, and even more preferably 1 to 50 g/10 min. MFR is measured in accordance with ASTM D1238 using a melt indexer at a temperature of 372° C. and a weight of 5 kg.

Although the fluororesin can be used as powder particles of fluororesin, the fluororesin particles are preferably finely dispersed in the coating film to achieve excellent tack-free properties. Therefore, the dispersion obtained by emulsion polymerization is preferably added and used as a raw material for a coating. The average particle diameter of the fluororesin particles is preferably 0.5 μm or less, and particularly preferably 0.3 μm or less. With the present invention, the average particle size refers to the particle size at an integrated value of 50% in the particle size distribution determined by a laser diffraction and scattering method.

### [Silane Coupling Agent]

In the coating composition of the present invention, a silane coupling agent is preferably included in order to improve adhesion between the coating film and the rubber sealing member.

Conventionally known silane coupling agents can be used as the silane coupling agent that can be used in the coating composition of the present invention, and examples can include, but are not limited to, γ-(2-aminoethyl)aminopropyltrimethoxysilane, γ-aminopropyltriethoxysilane, N-β (aminoethyl) γ-aminopropyltrimethoxysilane, N-β (aminoethyl) γ-aminopropylmethyldimethoxysilane, and other silane coupling agents containing an amino group; γ-glycidoxypropyltrimethoxysilane, γ-glycidoxypropylmethyldimethoxysilane, and other silane coupling agents containing a glycidyl group; γ-mercaptopropyltrimethoxysilane and other silane coupling agents containing a mercapto group; vinyltriethoxysilane, vinyltrimethoxysilane, vinyltris(methoxyethoxy) silane, and other silane coupling agents containing a vinyl group; γ-(meth)acryloyloxypropyltrimethoxysilane, γ-(meth)acryloyloxypropyltriethoxysilane, γ-(meth)acryloyloxypropyldimethoxymethylsilane, and other silane coupling agents containing a (meth)acryloyl group; γ-isocyanate propyltriethoxysilane, γ-isocyanate propyltrimethoxysilane, and other silane coupling agents containing an isocyanate group; and the like.

The silane coupling agent should be blended in an amount of 0.5 to 3.0% by mass, especially 0.8 to 2.5% by mass, based on the solid content of the total resin (sum of HNBR and fluoropolymer) in the coating composition. If the amount of the silane coupling agent is less than the aforementioned range, the aforementioned effect obtained by mixing the silane coupling agent cannot be sufficiently achieved. On the other hand, if the amount of silane coupling agent is higher than the aforementioned range, the tack-free properties of the coating film may be impaired as compared to when in the aforementioned range.

### [Preparation of the Coating Composition]

The coating composition according to the present invention may be any form of water or solvent based coating composition or powder coating composition, but the composition is, from an environmental perspective, preferably a water-based coating composition. Furthermore, exemplary methods for preparing the coating composition include, but are not limited to, the methods described below.

When the coating composition of the present invention is prepared as a water based coating composition, the coating composition can be prepared by a method of mixing: an aqueous dispersion of HNBR (latex) or a precursor solution of HNBR, prepared by a conventionally known method; an aqueous dispersion or mixture of fluororesin particles (for example, an existing fluororesin water based coating or the like), at a ratio (solid mass ratio) of 25:75 to 55:45; and if necessary, a silane coupling agent, or another additive as described below.

The aqueous dispersion of HNBR can be prepared by a conventionally known method, and can be prepared by, but not limited to, emulsion polymerization, suspension polymerization, a method using an emulsifying device such as a high-speed homogenizer or the like, an inversion emulsification method, a phase inversion temperature emulsification method, and an emulsification method using a surfactant, or the like.

In the aqueous dispersion of HNBR, HNBR particles having an average particle diameter of 0.01 to 0.5 μm are preferably dispersed to be 10 to 70% by weight in the aqueous dispersion.

The aqueous dispersion of fluororesin particles used in the coating composition can be prepared by dispersing the fluororesin uniformly and stably in an aqueous medium using a surfactant or the like, or by water based emulsion polymerizing the fluororesin using a surfactant and an initiator, or, if necessary, a chain transfer agent or the like. Commercially available aqueous dispersions of fluororesins prepared from aqueous dispersions obtained by aqueous emulsion polymerization can also be used.

In the fluororesin aqueous dispersion, the fluororesin particles having an average particle diameter of 0.01 to 180 μm are preferably dispersed to be 10 to 70% by weight in the aqueous dispersion. In particular, aqueous dispersions of fluororesin particles having an average particle diameter of 0.1 to 0.3 μm are preferably used.

In the coating composition of the present invention, the aqueous dispersion of the aforementioned HNBR and an aqueous dispersion of fluororesin may be used as is, but a filler and various additives used in an ordinary coating may be added in accordance with required characteristics, such as dispersibility, conductivity, foaming prevention, wear resistance improvement, and the like.

Examples can include surfactants (examples thereof include polyoxyethylene alkyl ether, polyoxyethylene alkyl phenyl ether type nonionic surfactants; such as LEOCOL® manufactured by LION, Inc., the TRITON® and TERGITOL® series manufactured by the Dow Chemical Company, and EMULGEN® manufactured by KAO, Inc., sulfosuccinates; such as LIPAL® manufactured by LION, Inc., EMAL®, PELEX® manufactured by KAO, Inc., and the like, anionic surfactants; such as alkyl ether sulfonic acid sodium salts, sulfate mono-long chain alkyl type, and polycarboxylate, acrylic salt type polymer surfactants, such as, LEOARL® manufactured by LION, Inc., OROTAN® manufactured by the Dow Chemical Company, and the like), film forming agents (examples include polymeric film forming agents such as polyamides, polyamide imides, acrylics, acetates, and the like; higher alcohols and ethers; polymeric surfactants having a film forming effect, and the like), and thickeners (examples include soluble celluloses, solvent dispersion thickeners, sodium alginates, caseins, sodium caseinates, xanthan gums, polyacrylic acids, and acrylic esters); and the like.

### Aqueous Coating Composition

The water-based coating composition of the present invention can be prepared by mixing and stirring a water-based dispersion of HNBR prepared by the aforementioned method, a water-based dispersion of a fluororesin, or an aqueous composition (solution, ready-made coating, or the like).

In aqueous coating composition, water is preferred as the main medium from the perspective of the environmental and costs. However, a polar solvent that is compatible with water can be added from the perspective of adjusting rheological properties such as the viscosity of the coating composition, improving the dispersibility of fillers, or improving the volatility of the solvent when drying after coating to form a uniform paint film.

Examples of these polar solvents include, but are not limited to, methanol, ethanol, 1-propanol, 2-propanol, ethylene glycol, diethylene glycol, diethylene glycol monomethyl ether, triethylene glycol monomethyl ether, diethylene glycol monoethyl ether, triethylene glycol monoethyl ether, ethylene glycol monobutyl ether, diethylene glycol monobutyl ether, triethylene glycol monobutyl ether, ethylene glycol hexyl ether, diethylene glycol hexyl ether, ethylene glycol monobutyl ether acetate, diethylene glycol monobutyl ether acetate, ethylene glycol phenyl ether, propylene glycol, propylene glycol monomethyl ether, dipropylene glycol monomethyl ether, tripropylene glycol monomethyl ether, propylene glycol monopropyl ether, dipropylene glycol monopropyl ether, propylene glycol monobutyl ether, dipropylene glycol monobutyl ether, tripropylene glycol monobutyl ether, propylene glycol methyl ether acetate, dipropylene glycol methyl ether acetate, propylene glycol diacetate, propylene glycol phenyl ether, polyethylene glycol, polypropylene glycol, 3-methoxy N,N-dimethylpropanamide, 3-butoxy N,N-dimethylpropanamide, N-methyl-2-pyrrolidone (NMP), N-ethylmorphophorin, N-formylmorphophorin, N-acetylmorphophorin, N,N′-dimethylethyleneurea, N,N-dimethylacetamide or N, N-dimethylformamide, γ-butyrolactone, and the like.

### Solvent Based Coating Composition

A solvent-based coating composition can be prepared by preparing liquid HNBR, an HNBR solvent dispersion, fluororesin solution, or fluororesin solvent dispersion, and then stirring and mixing. Various types of exemplified additives for water-based coating compositions can be used.

### Powder Coating Composition

When used as a powder coating composition, the aqueous dispersion of HNBR and aqueous dispersion of fluororesin prepared by the above methods can be prepared by agitating to coagglomerate the HNBR and the fluororesin. Specifically, composite powder containing primary particles of HNBR and fluororesin can be prepared by agitating at a speed of 100 to 500 rpm for 1 to 60 minutes in order to granulate agglomerated granules with an average particle diameter of 1 to 200 μm, followed by separation, washing and drying. Large coarse particles with particle diameters of at least 200 μm generated by aggregation or over-granulation can be crushed into fine particles as necessary.

Note that an electrolytic material, such as HCl, H₂SO₄, HNO₃, H₃PO₄, Na₂SO₄, MgCl₂, CaCl₂), HCOONa, CH₃COOK, (NH₄)₂CO₃, or the like is preferably added to chemically aggregate rubber/fluororesin primary particles. Additionally, an organic solvent incompatible with water (preferably a fluorinated solvent) is preferably added as needed so as to uniformly granulate the aggregated particles.

### Other

A variety of organic and inorganic fillers can be added to the coating composition according to the present invention, based on the characteristics required thereof. Examples of organic fillers include engineering plastics, such as polyarylene sulfides, polyether ether ketones, polyamides, polyimides, and the like. Exemplary inorganic fillers include metal powders, metal oxides (aluminum oxide, zinc oxide, tin oxide, titanium oxide, etc.), glass, ceramics, silicon carbides, silicon oxides, calcium fluorides, carbon black, graphites, micas, barium sulfates, etc. Various shapes of fillers can be used, such as particles, fibers, flakes, and the like. However, in order to obtain the flexibility in the coating film required for the coating composition of the present invention, a particle shaped filler with low anisotropy is preferably used, and a spherical filler is more preferably used.

Furthermore, in addition to the above, a pigment and various additives conventionally used in coatings can be added in accordance with required characteristics, such as electrical conductivity, foam prevention, improved wear resistance, improved corrosion resistance, coloring, and the like.

These fillers can be used to provide various properties to the coating film.

Although the amount of filler cannot be generally specified depending on the type of filler used, a range of 0.1 to 10% by mass of coating solid in the coating composition (total amount of HNBR, fluororesin, and filler) is preferable. If the amount of added filler is below this range, the improvement to the properties due to the added filler will be insufficient, but if the amount is above this range, tack-free properties will be inferior and the elasticity will be degraded as compared to a case where the amount is in the aforementioned range.

When the coating composition is a liquid coating such as a water based coating, etc., the filler can be used by dispersing the filler in a liquid medium such as water or the like.

### (Coating Method)

The coating composition of the present invention can be coated on a surface of a rubber sealing member by a conventionally known coating method such as spray coating, dip coating, and the like.

After coating, the coated coating composition is heat treated to the crosslinking temperature of the HNBR to form a coating film. As described above, in the coating composition of the present invention, the crosslinking temperature of the HNBR is as low as 120 to 200° C. Therefore, even if the coating is applied directly to a rubber sealing member and heat treated, a uniform coating film can be formed without damaging the rubber sealing member.

Note that heating conditions (baking conditions) of the coating composition of the present invention vary depending on the composition and form of the coating composition, the amount of coating, the desired crosslinking temperature, and the like, and thus cannot be generally specified. However, the coating composition is preferably heated at a temperature higher than the crosslinking temperature of the HNBR for 5 to 120 minutes. Furthermore, crosslinking can be accelerated by performing the heat treatment a plurality of times, and wear resistance can also be improved.

Furthermore, the coating composition of the present invention has excellent adhesion to the rubber sealing member, and therefore can be coated directly onto a substrate surface without requiring a primer layer, surface treatment of the substrate, and the like.

### (Rubber Sealing Member)

As mentioned above, the paint composition of the present invention can form a coating film at low temperature, can provide excellent tack-free (non-tacking) properties so as to not adhere whatsoever when lightly touched to metal, has excellent adhesion to rubber substrates, and has elasticity that can track the expansion and contraction of the rubber substrate. Therefore, the composition is suitable for use as a surface coating on rubber sealing members that come in contact with metal as an opposing material, such as O-rings, oil seals, gaskets, valve seals, or check valves such as umbrella type check valves and the like.

Rubber sealing members can be molded from various rubbers or thermoplastic elastomers (collectively referred to as “rubber materials”), depending on the type and application.

Although not restricted to these, examples of the rubber include saturated polyolefin based rubbers such as ethylene-propylene copolymers, ethylene-α-olefin copolymers, propylene-α-olefin copolymers, chlorinated polyethylene, and chlorosulfonated polyethylene; α-olefin diene copolymer rubbers such as ethylene-propylene-diene copolymers, α-olefin-diene copolymers, ethylene-diene copolymers, propylene-diene copolymers, and halides and hydrogenated products thereof; diene copolymer rubbers such as isoprene rubbers, butadiene rubbers, and halides and hydrogenated products thereof, silicone based rubbers such as methyl silicone rubbers, vinyl methyl silicone rubbers, and phenyl methyl silicone rubbers; fluorine rubbers such as fluorinated silicone rubbers, fluorinated vinylidene rubbers, tetrafluoroethylene-propylene rubbers, and tetrafluoroethylene-perfluoromethyl vinyl ether rubbers; styrene-diene copolymer rubbers such as styrene-butadiene copolymers and styrene-isoprene copolymers; butyl based rubbers such as butyl rubbers and halides and hydrogenated products thereof; chloroprene based rubbers such as chloroprene rubbers and chloroprene and halides and hydrogenated products thereof; epichlorohydrin based rubbers such as epichlorohydrin rubbers and epichlorohydrin-ethylene oxide rubbers, urethane rubbers such as polyetherurethane rubbers and polyesterurethane rubbers; acrylonitrile-butadiene based rubbers such as acrylonitrile-butadiene rubbers and halides and hydrogenated products thereof; natural rubbers; and the like.

Exemplary thermoplastic elastomers include polystyrene based thermoplastic elastomers such as styrene-butadiene-styrene block copolymers, styrene-isoprene-styrene block copolymers, styrene-ethylene-butadiene-styrene block copolymers, styrene-isoprene-butadiene-styrene block copolymers, and styrene-ethylene-propylene-styrene block copolymers, and halides and hydrogenated products thereof; polyolefin based thermoplastic elastomers such as blends of olefin resins and olefin rubbers and blends of olefin resins and olefin-diene copolymers, and halides and hydrogenated products thereof; polyurethane based thermoplastic elastomers, polyester based thermoplastic elastomers, and the like.

Of the above rubber materials, the paint composition of the present invention can provide the desired tack-free properties toward metals while maintaining excellent adhesion, especially to sealing members made of fluorine rubber, butyl rubber, and ethylene-propylene rubber (EPM, EPDM). Furthermore, a crosslinking agent, polymerization initiator, filler, pigment, ultraviolet absorber, anti-aging agent, foaming agent, antifoaming agent, antioxidant, or the like can be added based on a conventional known formulation to the aforementioned rubber material forming the rubber sealing member.

The coating film formed from the coating composition of the present invention has excellent durability and is able to maintain tack-free properties (non-tacking properties) over a long period of time, and therefore the composition is particularly suitable for use as a coating for covering a surface of automotive seal rings or the like.

### (Coating Film)

The thickness of the surface coating film of the rubber sealing member can be selected according to the type of sealing member and the application, or the like. However, when the rubber sealing member is used to provide tack-free properties to a sealing ring or check valve as described above, the coating should be applied such that the film thickness after heat treatment is 5 μm or more, especially 5 to 300 μm. If the film thickness is thinner than the above range, a continuous coating film cannot be formed as compared to when the film thickness is in the aforementioned range, which may cause coating film defects and may also cause early loss of coating film performance (tack-free properties and slipperiness) due to wear. On the other hand, even if the film thickness is thicker than the aforementioned range, further improvement in coating performance, such as tack-free properties, cannot be expected, and thus the economic efficiency thereof is inferior.

The coating film formed on the surface of the rubber sealing member has excellent tack-free properties and does not stick to metal. Therefore, a sealing member with this coating film formed on a surface will exhibit excellent sealing performance as a sealing member.

The coating film formed on the surface of the rubber sealing member has a contact angle with pure water of 90 degrees or more, preferably 95 degrees or more, indicating high tack-free properties from this perspective.

Furthermore, the coating film formed on the surface of the rubber sealing member has excellent adhesive strength (adhering power) to the rubber sealing member. As a result, a rubber sealing member with this coating film formed on the surface can have excellent and stable tack-free properties, abrasion resistance, elasticity, and the like, of the coating film over a long period of time. A method for measuring peel strength against rubber sealing members is described below.

### EXAMPLES

### (Test Piece Fabrication)

The following three types of test pieces were used to evaluate the performance of rubber sealing members.
Fluorinated vinylidene rubber (FKM) (size: 100 mm×50 mm×2 mm thick, manufactured by Paltec Co., Ltd.)
Ethylene propylene diene rubber (EPDM) (size: 100 mm×50 mm×2 mm thick, manufactured by Paltec Co., Ltd.)
Butyl rubber (IIR) sheet (size: 100 mm×50 mm×2 mm thick, manufactured by Paltec Co., Ltd.)

A coating was performed by spraying the coating compositions of the examples and comparative examples described below to an air blown substrate using an air spray coating gun (W-88-10E2 φ 1 mm nozzle (manual gun), manufactured by Anest Iwata Corporation) at an air pressure of 2.5 to 3.0 kgf/cm². Test pieces were fabricated by coating the coated liquid mass so as to be approximately 0.65 g (0.60 to 0.70 g) per substrate. Note that the baking conditions are as follows.

After heating and drying at 60° C. for 10 minutes, transferring to another oven and heating at 120° C. for 10 minutes were performed, and then transferring to another oven was performed to perform a heat crosslinking treatment at 180° C. for 10 minutes. Furthermore, transferring to another oven and heating at 120° C. for 60 minutes were performed to perform a secondary crosslinking treatment.

### (Evaluation Method)

### [State of Coating Formation (Visual Observation)]

The obtained coating film was observed visually to confirm the presence or absence of tack or the like. The product was considered acceptable if no cracks or other defects were observed. The results are shown in Table 2.

### [Tack-Free Evaluation (Tacking Test)

The tack force (peak value) (gf) received by a probe was measured using a TAC 1000 Tacking tester made by Rhesca Corporation by pressing a 5 mm diameter probe (SUS304 material) at room temperature against the coating film at a speed of 5 mm/min and a load of 100 gf, maintaining the load of 100 gf for 3 seconds, and then pulling away at a speed of 10 mm/min. The results are shown in Table 2.

### [Mold-Releasing Property Evaluation (Pure Water Contact Angle (°))]

Using the test piece obtained by the method described above, the contact angle (°) (droplet size: approximately 2 μL) of pure water was measured using a fully automatic contact angle meter (Kyowa Interface Science Co., Ltd., DM-701) in a measurement environment at 25° C. and relative humidity of 60%. The results are shown in Table 2.

### [Adhesion Evaluation (Cross Cutting Test)]

The surface of the coating film of the test piece obtained by the method described above was subjected to the following cross cutting test in accordance with JIS K 5600.5.6.

(1) Using a cutter knife, 11 cuts are made on the test surface to reach bare metal, and 100 grid marks are made. A cutter guide was used, and the interval of the cuts was 1 mm.

(2) Scotch Tape® is strongly pressed against the grid square portion, an edge of the tape is peeled off at an angle of 45 degrees at once, and then the condition of the grid square is evaluated.

The evaluation results were displayed at the number of peeled grid squares (per 100 pieces). The results are shown in Table 2.

### [Coating Film Stretchability Evaluation]

Dumbbell-shaped specimens (in accordance with ASTM D-2116) were cut out from a test piece made by coating the coating compositions of Examples 2 to 5 onto a butyl rubber (IIR) sheet, and then a stretching test was performed with a constant stretching repeated fatigue tester (MYSS Tester, H9537/H9606 manufactured by MYS-TESTER Company Limited) under the following conditions:

Measurement temperature: 100° C., Mutation stroke: 11 mm (50% stretching), Stretching speed and return speed: 11 mm/min, Number of times stretched: 100 times. After the test was over, the condition of the coating film was confirmed. None of the coating films made of the coating compositions of Examples 2 to 5 exhibited cracking or peeling.

### [Coating Wear Resistance Test]

The surface of an aluminum substrate (JIS A5052 compliant material, 100 mm×50 mm, 1 mm thick) was degreased using isopropyl alcohol, and then, a sandblaster (Numablaster SGF-4(A)S-E566, available from Fuji Manufacturing Co., Ltd.) was used to subject the surface to roughening by shot blasting using #60 alumina (Showa Blaster, available from Showa Denko KK). Air pressure of 2.5 to 3.0 kgf/cm² was used to spray and coat the coating compositions of the examples and comparative examples described below. Test pieces were fabricated by coating the coated liquid mass so as to be approximately 0.65 g (0.60 to 0.70 g) per substrate.

Note that the baking conditions are as follows.

After heating and drying at 60° C. for 10 minutes, transferring to another oven and heating at 120° C. for 10 minutes were performed, and then transferring to another oven was performed to perform a heat crosslinking treatment at 180° C. for 10 minutes. Furthermore, transferring to another oven and heating at 120° C. for 60 minutes were performed to perform a secondary crosslinking treatment.

These test pieces were subjected to a wear resistance test performed using a Suga Wear Testing Machine NUS-ISO3 available from Suga Test Instruments Co., Ltd., in accordance with JIS K5600 May 10 (test piece reciprocating method). The test conditions were as described below.
Load: 1 N
Number of reciprocations: 100 (stroke 30 mm)
Abrasive paper used: Silicon carbide paper, P-400 grade (12 mm wide)
From the change in the measured mass before and after measurement, wear resistance (WR) was determined by the following calculation equation. Measurements were made n=3 times and the average values obtained are shown in Table 2.

$$WR = \frac{NS ρ}{10 ( W 1 - W 2 )} [ ds / μm ] \qquad [ Equation 1 ]$$

N: number of reciprocations (ds: double strokes)
W1: mass before testing (mg)
W2: mass after testing (mg)
S: area of the wear portion (cm²)
p: test material density (g/cm³)
Value inserted from experimental condition: N: 100 ds
S: 1.2 cm×3 cm
The density ρ was a calculated value calculated from the composition ratios shown in Table 1, using 1.02 g/cm³ as the average specific gravity value for HNBR and 2.15 g/cm³ as the average specific gravity value for FEP, PFA, and PTFE.

### Example 1

2.08 g of pure water and 203.3 g of FEP aqueous dispersion (Teflon® FEP 120-JR, FEP resin solid content 54.5 mass %, manufactured by Chemours-Mitsui Fluoroproducts Co., Ltd) as the fluororesin were placed in a 1 L stainless steel beaker and stirred for 3 minutes at 200 rpm using a stirrer with a 4-blade down-flow type propeller. Next, 268.27 g of an aqueous dispersion (latex) of hydrogenated acrylonitrile butadiene rubber (HNBR R2230LX, manufactured by ZEON Corporation, HNBR resin solids content 41.3% by mass) was added, and the mixture was further stirred at 150 rpm for 5 minutes. 7.79 g of aqueous carbon black dispersion adjusted to a concentration of 25% by mass was added to the above mixture and stirred at 250 rpm for 5 minutes. 16.10 g of a 6% methylcellulose aqueous solution and 2.46 g of a silane coupling agent (KBM-603 manufactured by Shin-Etsu Chemical Co., Ltd.) were added thereto and then stirred at 250 rpm for 15 minutes to obtain 500 g of a coating composition.

### Example 2, Example 3, and Comparative Examples 1 and 2

Coating compositions were prepared by the same procedures as Example 1, and the composition ratio of fluoropolymer (FEP) and HNBR in the coating was adjusted to the proportions shown in Table 1 to achieve the same concentrations as in Example 1.

TABLE 1

| | HNBR | FEP | PFA | PTFE | Silane |
|---|---|---|---|---|---|
| | [% by | [% by | [% by | [% by | Coupling |
| | mass] | mass] | mass] | mass] | Agent |
| Example 1 | 50 | 50 | — | — | Added |
| Example 2 | 40 | 60 | — | — | Added |
| Example 3 | 30 | 70 | — | — | Added |
| Example 4 | 30 | — | 70 | — | Added |
| Example 5 | 30 | — | — | 70 | Added |
| Comparative | 20 | 80 | — | — | Added |
| Example 1 | | | | | |
| Comparative | 10 | 90 | — | — | Added |
| Example 2 | | | | | |
| Comparative | 100 | — | — | — | Added |
| Example 3 | | | | | |

### Example 4

A coating composition was prepared with the same content ratio as in Example 3, except that a PFA aqueous dispersion (Teflon® PFA 334-JR manufactured by Chemours-Mitsui Fluoroproducts Co., Ltd., PFA resin solid fraction: 60.0% by weight) was used as the fluororesin.

### Example 5

A coating composition was prepared with the same content ratio as in Example 3, except that a PTFE aqueous dispersion (Teflon® PTFE 31-JR manufactured by Chemours-Mitsui Fluoroproducts Co., Ltd., PTFE resin solid fraction: 59.4% by weight) was used as the fluororesin.

### Comparative Example 3

A coating composition was prepared by the same procedure as in Example 1 so as to have the same resin solid content (sum of fluoropolymer and HNBR) as the coating composition of Example 1, using only HNBR without using a fluororesin.

TABLE 2

| | Coating | | | | | | |
|---|---|---|---|---|---|---|---|
| | film | | | | Pure water contact | | |
| | condi- | Tack-free (gf) | | | angle (°) | | |
| | tion | FKM | EPDM | IIR | FKM | EPDM | IIR |
| Example 1 | Pass | 18.30 | 18.14 | 18.46 | 108.8 | 97.9 | 98.0 |
| Example 2 | Pass | 18.16 | 18.04 | 18.00 | 109.5 | 99.7 | 100.6 |
| Example 3 | Pass | 17.54 | 18.08 | 17.63 | 112.9 | 99.4 | 105.2 |
| Example 4 | Pass | 17.73 | 17.93 | 17.91 | 118.8 | 100.7 | 108.1 |
| Example 5 | Pass | 18.22 | 17.93 | 18.01 | 109.6 | 93.5 | 101.5 |
| Compar- | Crack | Not evaluated due to poor coating | | | | | |
| ative | gener- | film condition | | | | | |
| Example 1 | ation | | | | | | |
| Compar- | Many | | | | | | |
| ative | cracks | | | | | | |
| Example 2 | | | | | | | |
| Compar- | Pass | 355.37 | 196.02 | 259.02 | 84.3 | 26.1 | 53.7 |
| ative | | | | | | | |
| Example 3 | | | | | | | |

### INDUSTRIAL APPLICABILITY

The coating composition for a rubber sealing member of the present invention can form a coating film that provides excellent tack-free properties towards metal over a long period of time, and can be suitably used as a coating for rubber sealing parts such as seal rings, gaskets, valve seals, check valves, and the like.

1. A coating composition for a rubber sealing member, comprising: hydrogenated acrylonitrile butadiene rubber and perfluoro fluororesin, wherein the ratio of hydrogenated acrylonitrile butadiene rubber to perfluoro fluororesin (solid mass ratio) is 25:75 to 55:45.

2. The coating composition for a rubber sealing member according to claim 1, wherein the perfluoro fluororesin is a hot-melt perfluoro fluororesin.

3. The coating composition for a rubber sealing member according to claim 2, wherein the hot-melt perfluoro fluororesin is a tetrafluoroethylene hexafluoropropylene copolymer.

4. The coating composition for a rubber sealing member according to claim 1, comprising a silane coupling agent.

5. The coating composition for a rubber sealing member according to claim 1, wherein the hydrogenated acrylonitrile butadiene rubber and the perfluoro fluororesin are aqueous dispersion solutions.

6. The coating composition for a rubber sealing member according to claim 1, wherein the composition ratio of the hydrogenated acrylonitrile butadiene rubber and the perfluoro fluororesin (solid mass ratio) is 35:65 to 50:50.

7. A rubber sealing member, comprising a surface with a coating film containing hydrogenated acrylonitrile butadiene rubber and perfluoro fluororesin in a composition ratio of 25:75 to 55:45 (solid mass ratio).

8. The rubber sealing member according to claim 7, wherein the perfluoro fluororesin is a hot-melt perfluoro fluororesin.

9. The rubber sealing member according to claim 8, wherein the hot-melt perfluoro fluororesin is a tetrafluoroethylene hexafluoropropylene copolymer.

10. The rubber sealing member according to claim 7, wherein the tack force (peak value) received by a probe is 20 gf or less when a 5 mm diameter probe (SUS304 material) at room temperature is pressed against the coating film at a speed of 5 mm/min and a load of 100 gf, held at a load of 100 gf for 3 seconds, and then pulled away at a speed of 10 mm/min.

11. The rubber sealing member according to claim 7, which is a seal ring, gasket, valve seal or check valve.
